(19) United States
(12) Patent Application Publication
(10) Pub. No.: US 2009/0179432 A1
(43) Pub. Date: Jul. 16, 2009

(54) GRAVITATIONAL MAGNETIC ENERGY CONVERTER

(76) Inventor: Scott Wattenbarger, Bakerfield, CA (US)

Correspondence Address: STETINA BRUNDA GARRED & BRUCKER, 75 ENTERPRISE, SUITE 250, ALISO VIEJO, CA, 92656, US

(21) Appl. No.: 12/411,295

(22) Filed: Mar. 25, 2009

Related U.S. Application Data
(63) Continuation-in-part of application No. 11/656,679, filed on Jan. 23, 2007.

(51) Int. Cl. H02K 7/18

(52) U.S. Cl. 290/1 R

(57) ABSTRACT

Provided is an energy generation device including a base and a generator coupled to the base. The generator includes a shaft capable of rotating to generate electricity. A frame is coupled to the base and defines an inner perimeter. A first magnet is coupled to the frame. An arm is coupled to the shaft and defines a longitudinal arm axis. The arm is creates a fluid force in response to fluid passing over the arm in a direction substantially perpendicular to the longitudinal arm axis. The fluid force urges the arm in a first rotational direction. A hammer head is connected to the arm and includes a second magnet in magnetic communication with the first magnet to generate a magnetic force urging the second magnet in the first rotational direction. The fluid force and magnetic force collectively cause the arm to rotate in the first rotational direction.

### CROSS-REFERENCE TO RELATED APPLICATIONS

This application is a continuation-in-part of prior application Ser. No. 11/656,679, filed Jan. 23, 2007.

### STATEMENT RE: FEDERALLY SPONSORED RESEARCH/DEVELOPMENT

Not Applicable

### BACKGROUND

This invention relates in general to a power converting device. More specifically, the present invention relate to a magnetic energy generation device which utilizes magnetic forces to urge an electrical generator input shaft in a rotational direction.

Energy consumption is a very important issue in today's society. Currently, fossil fuels serve as the world's leading energy source. Although fossil fuels have served as a successful source of power for many years, there are inherent problems associated with fossil fuels upon combustion, including the by-product of pollution and exhaust that may be detrimental to the environment. Moreover, and separate and apart from the harmful affects of fossil fuel consumption, is the depletion of the world's fossil fuel supply. It is widely believed that the present supply of fossil fuels is quickly diminishing with many projections indicating that at the current rate of consumption, the supply of fossil fuels will be completely depleted in a matter of decades. Because the world has become very dependant on fossil fuels as an energy source, coupled with the unstable geopolitical environment of many oil producing nations, there is a substantial need to find an alternative energy source before completely depleting the world's reserves of fossil fuels.

The above-identified concerns have provided the impetus to create alternative forms of energy. There have been many attempts to develop an alternative energy source to replace the world's depleting supply of fossil fuels. A large number of these attempts are based on the concept of converting mechanical energy into electrical energy. Windmills and water-driven generators are exemplary of such attempts to convert mechanical energy into electrical energy. Although windmills and water-driven generators are capable of successfully convert mechanical energy into electrical energy, they depend on external elements for propulsion. In general, fluid flow (i.e., wind/water flow) moves over a fluid propelled device (i.e., windmill/water turbine) and propels the fluid propelled device. However, when the magnitude of the fluid flow is low, the fluid flow may not generate sufficient propelling forces to begin rotation of the fluid propelled device, or to sustain rotation of the fluid propelled device. As such, fluid-propelled devices generally cannot be solely relied upon as a dependable energy source.

In view of the foregoing, efforts have been taken to study other potential sources of energy. For instance, the force of gravity has been studied to determine whether it may be used as a possible source of energy. A gravitational field surrounds the Earth and applies a constant force at the Earth's surface. The gravitational field is numerically quantified by the acceleration of objects under its influence. The gravitational acceleration caused by the Earth's gravitational field is approximately equal to 9.8 m/s² or 32.17 ft/s².

In addition, considerable effort has been devoted to understanding magnets to determine whether they may serve as a source of energy. Magnets are objects that produce a magnetic field. There are two types of magnets; in particular, permanent magnets and electromagnets. Permanent magnets do not rely on an external influence to create their magnetic field. Conversely, electromagnets rely on an external current to create their field. Magnets are polar, with like poles repelling each other, and dissimilar poles attracting each other. The force of attraction generated by two magnets is represented by Coulomb's Law, which states that the force of attraction (F) is proportional to the attractive force of one magnet (M₁) multiplied by the attractive force of a second magnet (M₂) divided by the square of the distance between the two magnets (d²), or as written in equation format,

$$F = \frac{{M}_{1} {M}_{2}}{{d}^{2}} .$$

Although magnetic and gravitational forces have been known for a long time, they have not been effectively utilized to generate energy. As such, there is a need in the art for a device that is capable of generating energy by harnessing the forces caused by gravity as well as magnetic forces.

### BRIEF SUMMARY

According to an aspect of the present invention, there is provided a magnetic energy generation device comprising a base and a generator coupled to the base. The generator includes a shaft capable of rotating to generate electricity. A frame is coupled to the base and defines an inner perimeter. A first magnet is coupled to the frame. An arm is coupled to the shaft and defines a longitudinal arm axis. The arm is sized and configured to create a fluid force in response to fluid passing over the arm in a direction substantially perpendicular to the longitudinal arm axis. The fluid force urges the arm in a first rotational direction. A hammer head is connected to the arm and includes a second magnet in magnetic communication with the first magnet to generate a magnetic force to urge the second magnet in the first rotational direction. The fluid force and magnetic force collectively cause the arm to rotate in the first rotational direction.

The present invention is particularly useful given the above-mentioned shortcomings of fossil fuels. The device effectively combines magnetic forces with external propelling forces, such as gravity, wind or other fluid forces to generate energy. The magnetic forces and external forces effectively combine to provide continuous rotation of the arm for as long a duration as possible. In this manner, the magnetic forces may be utilized to preserve the rotational movement initially caused by the wind, or other external force. The magnetic forces may also contribute to initializing rotational movement of the arm. While it is understood that the motion system will encounter forces such as friction and other external elements that may ultimately slow or stop the motion system, it is contemplated that the combination of such features will provide a motion system that can operate for a substantially longer period than those known in the art.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of the gravitational, magnetic energy generation device.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

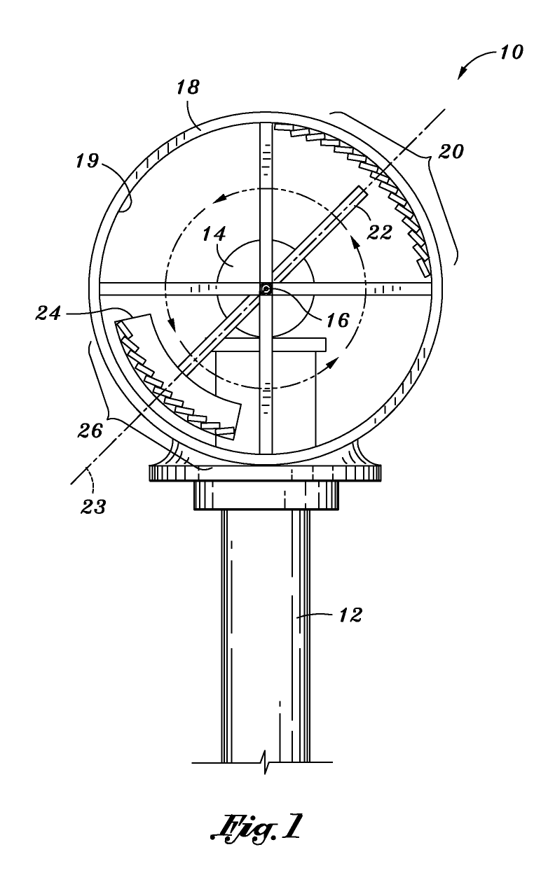

Referring now to the drawing, FIG. 1 illustrates an embodiment of a magnetic energy generation device 10. Various embodiments of the device 10 utilize magnetic forces, as well as additional forces, such as gravitational forces, fluid forces, or mechanical forces to generate electrical energy to provide a more efficient and reliable means of generating energy. In particular, magnetic forces may be combined with the additional forces to overcome frictional forces associated with rotation of an electrical generator. It is contemplated that in some instances non-magnetic forces may be used to initiate rotation of the device 10, while the magnetic forces may urge the device 10 in the direction of rotation to preserve the rotational movement of the device 10.

As depicted in FIG. 1, the magnetic energy generation device 10 includes a base 12 and an electrical generator 14 coupled to the base 12. The generator 14 includes a shaft 16 which is capable of rotating. The generator 14 is capable of converting the mechanical rotation of the shaft 16 into electrical energy. In order to rotate the shaft 16, rotational friction forces within the generator 14 are typically overcome. Various aspects of the present invention are directed toward utilizing magnetic forces to overcome the rotational friction forces to assist in initiating rotation of the device 10 and/or to assist in preserving rotation of the device 10.

A frame 18 is attached to the base 12 and defines an inner perimeter 19. An arm 22 is attached to the generator shaft 16 and defines a longitudinal arm axis 23. The arm 22 includes a hammer head 24 that is of considerable weight. Forces act on the arm 22 and cause the arm 22 to rotate within the frame 18. Rotation of the arm 22 may cause rotation of the generator shaft 16. In the embodiment shown in FIG. 1, the arm 22 is rotating in a counter-clockwise manner. However, it is understood that the arm 22 may also rotate in a clockwise manner without departing from the spirit and scope of the present invention.

According to one embodiment, the frame 18 is circular and defines an inner perimeter 19 having a diameter that is larger than the length of the arm 22. In this manner, the arm 22 is disposed within the inner perimeter 19. However, other embodiments of the device 10 may include an arm 22 having portions extending beyond the inner perimeter 19 of the frame 18. It is also contemplated that other implementations of the device 10 may include a non-circular frame 18.

The device 10 further includes a first magnet 20 coupled to the frame 18, and a second magnet 26 coupled to the hammer head 24. In general, magnets are materials having two poles, commonly referred to as a north pole and a south pole, or a positive pole and a negative pole. When two magnets are placed in close proximity to each other, they may be in magnetic communication with each other to generate a magnetic force between the two magnets. Magnetic ends having opposite polarities are typically attracted to each other, while magnetic ends having similar polarities are generally repelled from each other.

According to one embodiment, the first and second magnets 20, 26 are arranged such that the adjacent ends of the first and second magnets 20, 26 have similar polarities. In other words, the first and second magnets 20, 26 are arranged such that either the northern ends of the first and second magnets 20, 26 are adjacent to each other, or the southern ends of the first and second magnets 20, 26 are adjacent to each other.

In operation, the arm 22 rotates within the frame 18 thereby causing the generator shaft 16 to rotate. Several forces may act upon the arm 22 to cause it to rotate. As explained in more detail below, fluid forces, gravitational forces, and magnetic forces may all contribute to propelling the arm 22 in a rotational direction. It is understood that frictional forces may oppose rotation of the arm 22. Accordingly, in one embodiment, the magnetic forces and gravitational forces collectively overcome the frictional forces. In other embodiments, other forces, such as fluid forces, or a motor may also contribute to overcoming the frictional forces.

With regard to the fluid forces, the arm 22 is configured to rotate in response to fluid passing over the arm 22. In one embodiment, the arm 22 may be configured to generate a fluid force as the fluid passes over the arm 22 in a direction substantially perpendicular to the longitudinal arm axis 23. The fluid force may urge the arm 22 in the first rotational direction. In this regard, the arm 22 may be propelled in a manner similar to a conventional windmill. Fluid forces may include forces generated by wind, pressurized steam, flowing water, or other moving fluids. The fluid forces may be sufficient to initiate rotation of the arm 22, and in some instances, maintain rotation of the arm 22. However, when the flow of fluid slows down, additional propelling forces may be required to preserve rotation of the arm 22.

In addition to fluid forces, gravitational forces may also urge the arm 22 in a first rotational direction. More specifically, gravity may urge the hammer head 24 in the first rotational direction to propel the arm 22. The arm 22 may be configured to rotate in a rotational plane that is substantially parallel to the force of gravity.

According to one embodiment, the frame 18 is divided into four quadrants; namely, the first, second, third and fourth quadrants. The first quadrant is defined as the quadrant wherein gravitational forces begin to urge the hammer head 24 to accelerate. Gravity continues to urge the hammer head 24 to accelerate through the second quadrant. In the third quadrant, the hammer head 24 begins to rotate in a direction opposing the force of gravity. As such, the gravitational forces in the third quadrant act upon the arm 22 in a direction opposing rotation. The fourth quadrant is the portion of the frame 18 located between the third and first quadrants. In the fourth quadrant, gravitational forces continue to act in a direction opposing rotation. However, the rotational momentum of the arm 22, as well as other rotational forces (i.e., fluid forces and magnetic forces) may carry the arm 22 through the third and fourth quadrants.

As gravity causes the hammer head 24 to accelerate, the shaft 16 rotation also accelerates. However, frictional forces may act upon the generator shaft 16 in the direction opposing rotation. In order to achieve rotation of the generator shaft 16, the forces acting on the arm 22 urging the arm in the first rotational direction generally overcome than the frictional force acting on the shaft 16. Gravity urges the arm 22 to rotate through the first and second quadrants; however, as the hammer head 24 rotates into the third quadrant of the frame 18, the gravitational and frictional forces act in a direction opposite of rotation, which may cause the arm 22 to decelerate. The momentum of the hammer head 24, after rotating through the first and second quadrants, may not be sufficient to overcome the gravitational and frictional forces to carry the hammer head 24 completely through the third and fourth quadrants. Furthermore, the fluid forces may not be strong enough to overcome the gravitational and frictional forces. Therefore, in order for the arm 22 to complete a rotation, an additional force(s) may be required to act on the arm 22. According to one implementation of the device 10, the magnetic force created by the first and second magnet 20, 26 provides a sufficient external force to propel the arm 22 through the remainder of its rotation.

The magnetic force created between the first and second magnets 20, 26 may sufficiently counteract the gravitational and frictional forces acting against rotation, and accelerate the arm 22 through the third and fourth quadrants of the frame 18. In addition, the magnetic force may also be coupled with the fluid forces and the rotational momentum of the arm 22 to preserve rotation of the arm 22.

The magnetic force (F) created by the first and second magnets 20, 26 may be equal to

$$F = \frac{{M}_{1} {M}_{2}}{{d}^{2}} ,$$

where M₁ is the attractive force of the first magnets 20, M₂ is the attractive force of the second magnets 26, and d² is the square of the distance between the first and second magnets 20, 26. Therefore, the magnetic force may be increased using magnets with a greater attractive force, or by decreasing the distance between the first and second magnets 20, 26.

According to one embodiment, the first and/or second magnets 20, 26 are permanent magnets. A permanent magnet is a magnet which may not rely on an outside influence to create its magnetic field. In another embodiment of the invention, it is contemplated that the first and/or second magnets 20, 26 are electromagnets. Electromagnets generally rely on an electric current in order to create a magnetic field. The strength of an electromagnetic field may be increased by increasing the electric current. In addition, the polarity of the electromagnet can be changed by changing the direction of the electric current.

The size of the hammer head 24 and/or the size of the first and second magnets 20, 26 may vary depending on the size of the overall device 10. As the weight of the hammer head 24 increases, its rotational momentum may also increase. Therefore, if there is a load, or large friction force caused by the generator 14, a heavier hammer head 24 may be used. However, a heavy hammer head 24 will require a larger magnetic force or fluid force to complete its rotation through the third and fourth quadrants. As such, magnets having a larger attractive force may be employed.

According to one embodiment, the first magnet 20 is comprised of a plurality of magnets coupled to the frame 18, as depicted in FIG. 1. The plurality of magnets may be arranged at an angle relative to the frame 18 inner perimeter to maximize the force propelling the arm 22 in the direction of rotation. The magnets are located within a magnet zone. The magnet zone is the portion of the frame 18 containing magnets. In one particular embodiment, the magnet zone comprises at least one quarter of the frame inner perimeter. Although the magnet zone is in the fourth quadrant, as shown in FIG. 1, the magnet zone may be located anywhere along the frame 18. For instance, the first magnet 20 may “push” or “pull” the arm 22 through the rotation. The first magnet 20 may “push” the arm 22 by urging the arm 22 in the first rotational direction from a location behind the hammer head 24. Likewise, the first magnet 20 may “pull” the arm 22 by urging the arm 22 in the first rotational direction from a location ahead of the hammer head 24. It is also contemplated that the size and number of magnet zones may vary.

In another embodiment of the invention, the second magnet 26 is comprised of a plurality of magnets, as shown in FIG. 1. The second magnets 26 may be arranged at an angle relative to the first magnet(s) 20 in order to maximize the force propelling the arm 22 in the direction of rotation.

According to one aspect of the present invention, the first magnet 20 and/or second magnet 26 may include a magnetic shield to focus the direction of the magnetic field emanated by the first magnet 20 and the second magnet 26. The magnetic shield may be fabricated from a magnetically insulative material known by those skilled in the art.

It is contemplated that the present invention may be used in a variety of different applications. As such, the size of the device 10 may be tailored according to a particular application. For instance, it is envisioned that one embodiment may be used as a home unit electrical generator, while other embodiments may be slightly larger for industrial applications. Furthermore, it is contemplated that the arm 22 may be connectable to an input shaft located on equipment other than an electrical generator. For instance, the arm 22 may be connected to a pool pump to operate the pool pump. According to another embodiment, the device 10 may be larger, such as wind mill size, and may serve as an oil well pump.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A magnetic energy generation device comprising:
a base;
a generator coupled to the base, the generator having a shaft capable of rotating to generate electricity;
an arm coupled to the shaft and defining a longitudinal arm axis, the arm being sized and configured to create a fluid force in response to fluid passing over the arm in a direction substantially perpendicular to the longitudinal arm axis, the fluid force urging the arm in a first rotational direction;
a frame coupled to the base, the frame defining an inner perimeter;
a first magnet coupled to the frame; and
a hammer head connected to the arm, the hammer head having a second magnet being in magnetic communication with the first magnet to generate a magnetic force to urge the second magnet in the first rotational direction, the fluid force and magnetic force collectively causing the arm to rotate in the first rotational direction in a rotational plane substantially parallel to the force of gravity.

2. The energy generation device of claim 1, wherein the first magnet is a permanent magnet.

3. The energy generation device of claim 1, wherein the second magnet is a permanent magnet.

4. The energy generation device of claim 1, comprising a plurality of first magnets located within a magnet zone.

5. The energy generation device of claim 4, wherein the magnet zone comprises at least one-quarter of the frame inner perimeter.

6. The energy generation device of claim 5, wherein the frame is divided into a first quadrant, second quadrant, third quadrant, and fourth quadrant, wherein gravity causes the arm to accelerate in the first and second quadrant, and gravity causes the arm to begin to decelerate in the third quadrant, the magnet zone being located in the fourth quadrant.

7. The energy generation device of claim 4, wherein the plurality of first magnets are arranged at an angle relative to the frame inner perimeter to maximize the magnetic force urging the arm in the first rotational direction.

8. The energy generation device of claim 1, comprising a plurality of second magnets.

9. The energy generation device of claim 8, wherein the plurality of second magnets are arranged at an angle relative to the first magnet in order to maximize the magnetic force urging the arm in the first rotational direction.

10. A magnetic energy generation device for use with a generator having a shaft capable of rotating to generate electricity, the device comprising:
a base;
a frame coupled to the base, the frame defining an inner perimeter;
a first magnet coupled to the frame;
an arm connectable to the generator shaft, the arm being sized and configured to create a fluid force in response to fluid passing over the arm, the fluid force urging the arm in a first rotational direction in a rotational plane substantially parallel to the force of gravity; and
a hammer head connected to the arm, the hammer head having a second magnet being in magnetic communication with the first magnet to generate a magnetic force to urge the second magnet in the first rotational direction, the fluid force and magnetic force collectively causing the arm to rotate in the first rotational direction.

11. The energy generation device of claim 10, wherein the first magnet is a permanent magnet.

12. The energy generation device of claim 10, wherein the second magnet is a permanent magnet.

13. The energy generation device of claim 10, comprising a plurality of first magnets located within a magnet zone.

14. The energy generation device of claim 13, wherein the magnet zone comprises at least one-quarter of the frame inner perimeter.

15. The energy generation device of claim 14, wherein the frame is divided into a first quadrant, second quadrant, third quadrant, and fourth quadrant, wherein gravity causes the arm to accelerate in the first and second quadrant, and gravity causes the arm to begin to decelerate in the third quadrant, the magnet zone being located in the fourth quadrant.

16. The energy generation device of claim 13, wherein the plurality of first magnets are arranged at an angle relative to the frame inner perimeter to maximize the magnetic force urging the arm in the first rotational direction.

17. The energy generation device of claim 10, comprising a plurality of second magnets.

18. The energy generation device of claim 17, wherein the plurality of second magnets are arranged at an angle relative to the first magnet in order to maximize the magnetic force urging the arm in the first rotational direction.

19. A magnetic propulsion device connectable to a rotational input shaft, the device comprising:
a base;
a frame coupled to the base, the frame defining an inner perimeter;
a first magnet coupled to the frame;
an arm connectable to the rotational input shaft and defining a longitudinal arm axis, the arm being sized and configured to create a fluid force in response to fluid passing over the arm, the fluid force urging the arm in a first rotational direction in a rotational plane substantially parallel to the force of gravity; and
a hammer head connected to the arm, the hammer head having a second magnet being in magnetic communication with the first magnet to generate a magnetic force to urge the second magnet in the first rotational direction, the fluid force and magnetic force collectively causing the arm to rotate in the first rotational direction.

20. The energy generation device of claim 19, wherein the first magnet is a permanent magnet.
